(19) United States
(12) Patent Application Publication
(10) Pub. No.: US 2011/0232980 A1
(43) Pub. Date: Sep. 29, 2011

(54) CONTROL DEVICE OF HYBRID VEHICLE

(75) Inventors: Masaki NOMURA, Anjo (JP); Hiroaki KIOKA, Nishio (JP); Ken TAKEDA, Anjo (JP); Shintaro CHINEN, Toyota (JP)

(73) Assignee: AISIN AW CO., LTD., ANJO-SHI (JP)

(21) Appl. No.: 13/019,514

(22) Filed: Feb. 2, 2011

(30) Foreign Application Priority Data
Mar. 25, 2010 (JP) 2010-069162

(51) Int. Cl. B60W 20/00; B60W 10/06; B60W 10/08

(52) U.S. Cl. 180/65.265; 180/65.28; 180/65.285; 903/930

(57) ABSTRACT

A control device of a hybrid vehicle, configured with an engine; a motor that rotates together with the engine at least during traveling by using a driving force of the engine, and a speed change mechanism that shifts rotation of the engine and the motor to transmit the shifted rotation to a driving wheel. A zero torque control unit controls output torque of the motor to zero torque when a rotational speed of the motor reaches a predetermined rotation speed or more by driving rotation of the engine, and a motor temperature detection unit that detects a temperature of the motor. A motor protection control units that reduces a rotational speed of the engine when the temperature of the motor reaches an upper threshold value or more while the motor is being rotated at the predetermined rotational speed or more by the driving rotation of the engine.

### INCORPORATION BY REFERENCE

The disclosure of Japanese Patent Application No. 2010-069162 filed on Mar. 25, 2010 including the specification, drawings and abstract is incorporated herein by reference in its entirety,

### BACKGROUND OF THE INVENTION

The present invention relates to a control device that is mounted on, e.g., a hybrid vehicle, and more particularly to a control device of a hybrid vehicle, which controls output torque of a motor to zero torque when the rotational speed of the motor that operates together with an engine reaches a predetermined speed or more during traveling by using a driving force of the engine.

### DESCRIPTION OF THE RELATED ART

In recent years, various hybrid drive devices with improved fuel economy are proposed to address environmental issues, etc. One of such hybrid drive devices is a hybrid drive device in which a motor (a rotational electrical machine MG) is rotated together with an input shaft of a speed change mechanism (see Japanese Patent Application Publication No. JP-A-2008-132812). This hybrid drive device is known as a hybrid drive device that is preferably used in relatively inexpensive, small vehicles. That is, in an attempt to improve efficiency only in a traveling state where acceleration and deceleration are frequent, the hybrid drive device is structured so that EV traveling and an output assist by the motor are possible at the time of starting of the vehicle and in low to medium vehicle speed regions, and is also structured so that the vehicle travels by using the driving force of the engine in a high speed traveling state where acceleration and deceleration become less frequent.

In the hybrid drive device thus structured, the motor is also rotated together with the engine when the vehicle is traveling at a high speed by using the driving force of the engine. However, due to characteristics of the motor, it is difficult to output torque at a high rotational speed, and a driving force in the negative direction is generated (electric power is generated by a permanent magnet) in the motor if no electrical control is performed. Thus, zero torque control of applying a weak current according to the motor speed to the motor to control output torque to zero is performed when the rotational speed of the motor reaches a predetermined value or more.

### SUMMARY OF THE INVENTION

In such a hybrid drive device that performs the zero torque control, a higher current needs to be applied to the motor as the rotational speed of the motor increases. That is, the amount of heat generated by the motor increases as the rotational speed of the motor increases. Since coils and an insulating material in the motor have a heat-resistant temperature, the motor generally needs to be driven at a temperature equal to or less than this heat-resistant temperature. That is, if the amount of heat dissipated by the motor (the cooling amount) is larger than the amount of heat generated by the motor by the zero torque control, the temperature of the motor does not exceed the heat-resistant temperature, and thus the motor is in a continuous operation enabled region in which the motor can be continuously operated. If the amount of heat generation is larger than the amount of heat dissipation, the temperature of the motor can exceed the heat-resistant temperature, and thus the motor is in a continuous operation disabled region in which the motor cannot be continuously operated.

In such a hybrid drive device as described in Japanese Patent Application Publication No. JP-A-2008-132812, in order to ensure the continuous operation enabled region so that the continuous operation enabled region corresponds to the highest vehicle speed of the vehicle performance, measures have been taken such as improving the performance of a cooling structure (a coolant oil circulation system) of the motor, and increasing the size of the motor so as to reduce the current density and thus reduce the amount of heat generation. However, the continuous operation disabled region is a problem that occurs near the highest vehicle speed of the vehicle performance. That is, such measures as improving the performance of the cooling structure of the motor and increasing the size of the motor are taken in order to ensure the highest speed performance of the vehicle. Accordingly, the structure of such a hybrid drive device is not necessarily preferable for use in relatively inexpensive, small vehicles as described above. However, the motor cannot be protected near the highest vehicle speed of the vehicle performance, if cost reduction and a compact structure are implemented by merely simplifying the cooling system and reducing the size of the motor.

It is an object of the present invention to provide a control device of a hybrid vehicle, which is capable of protecting a motor while implementing cost reduction and a compact structure by simplifying a cooling system and reducing the size of the motor.

In the present invention according to a first aspect, a motor protection control unit reduces a rotational speed of an engine when a temperature of a motor reaches an upper threshold value or more while the motor is being rotated at a predetermined rotational speed or more by driving rotation of the engine and is being controlled to zero torque. Thus, a rotational speed of the motor can be reduced, and an amount of heat generation by the zero torque control can be reduced, whereby the temperature of the motor can be reduced, and the motor can be protected. This can eliminate the need to improve performance of a cooling structure of the motor, and to increase the size of the motor, whereby cost reduction and a compact structure of a hybrid vehicle can be implemented.

In the present invention according to a second aspect, the upper threshold value is set to be lower as the rotational speed of the motor becomes higher. This can prevent the temperature of the motor from increasing excessively according to the rotational speed of the motor, whereby the motor can be reliably protected.

In the present invention according to a third aspect, when the rotational speed of the engine is reduced by the motor protection control unit, the vehicle speed maintaining control unit shifts the speed ratio of the speed change mechanism toward a higher speed according to reduction in the rotational speed of the engine. This can prevent a vehicle speed from reducing with the reduction in the rotational speed of the engine.

In the present invention according to a fourth aspect, when the rotational speed of the engine is reduced by the motor protection control unit, the driving force maintaining control unit increases output torque of the engine so as to maintain a driving force that is transmitted to a driving wheel. This can prevent a vehicle speed from reducing due to a reduction in the driving force that is transmitted to a driving wheel.

In the present invention according to a fifth aspect, the motor is coupled to an input shaft of the speed change mechanism via a deceleration mechanism. Thus, although the output torque of the motor can be amplified and transmitted to the driving wheel, the motor rotates at a higher speed as compared to the rotational speed of the engine. However, since the motor protection control unit reduces the rotational speed of the engine when the temperature of the motor reaches the upper threshold value or more, the rotational speed of the motor can be significantly reduced, whereby the motor can be reliably protected.

### BRIEF DESCRIPTION OF THE DRAWINGS

FIG. 1 is a block diagram of a control device of a hybrid vehicle according to the present invention;

FIG. 2 is a diagram showing a temperature upper threshold map;

FIG. 3 is a flowchart illustrating motor protection control of the present invention;

FIG. 4 is an illustration illustrating the driving force of a vehicle based on the relation between engine torque and the engine speed;

FIG. 5 is a timing chart illustrating the motor protection control in the case where there is a margin for increasing output torque of an engine; and

FIG. 6 is a timing chart illustrating the motor protection control in the case where there is not a margin for increasing the output torque of the engine.

### DETAILED DESCRIPTION OF THE EMBODIMENT

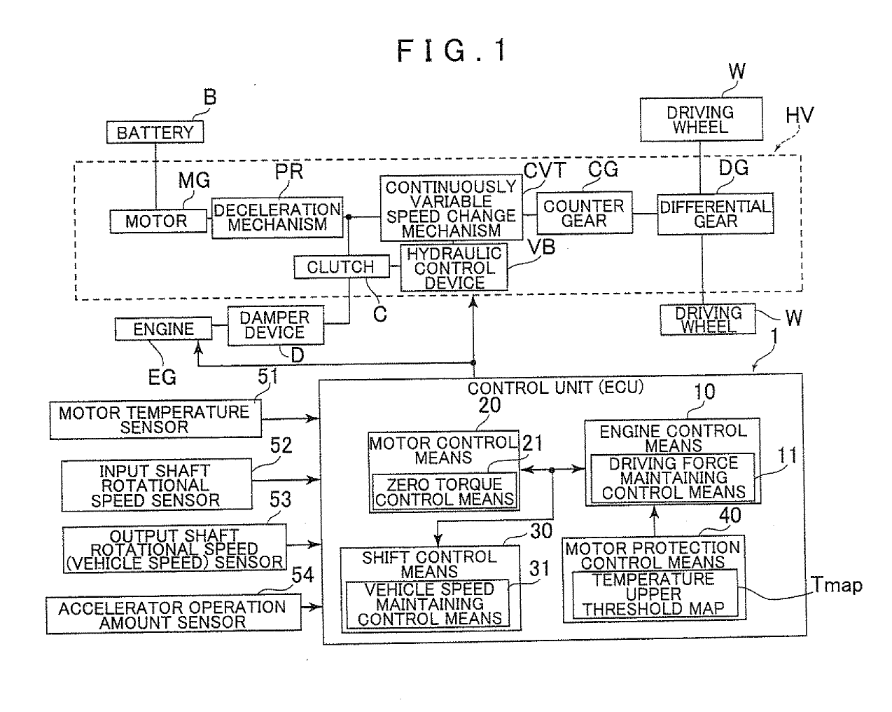

An embodiment of the present invention will be described below with reference to FIGS. 1 to 6. First, the general structure of a hybrid vehicle (a hybrid drive device HV) to which the present invention can be applied will be described with reference to FIG. 1.

As shown in FIG. 1, the hybrid vehicle to which the present invention can be applied is preferably used in, e.g., a front engine front drive (FF) type, and an engine EG is connected to the input side of the hybrid drive device HV via a damper device D, and the output side of the hybrid drive device HV is connected to right and left driving wheels W. The hybrid drive device HV includes a motor MG, a deceleration mechanism PR, a clutch C, a continuously variable speed change mechanism (a speed change mechanism) CVT, a hydraulic control device VB, a counter gear CG, a differential gear DG, and the like.

The motor MG is connected to a battery B, and the motor MG is connected to, e.g., an input shaft of the belt type continuously variable speed change mechanism CVT via the deceleration mechanism PR formed by, e.g., a single-pinion planetary gear or the like. The input shaft of the continuously variable speed change mechanism CVT (a rotating shaft of a primary pulley) is connected to the engine EG via the clutch C and the damper device D. The clutch C is engaged while the engine EG is being driven, and is disengaged while the engine EG is not being driven (while the engine EG is stopped), by using an oil pressure supplied from the hydraulic control device VB. That is, when the clutch C is in the engaged state (while the vehicle is traveling by using the driving force of the engine), the engine EG rotates together with the motor MG to transmit the rotation to the continuously variable speed change mechanism CVT.

The continuously variable speed change mechanism CVT is formed by, e.g., a belt type continuously variable speed change mechanism having a primary pulley, a secondary pulley, and a belt that is wound around both of the pulleys. The speed ratio is changed by hydraulically controlling the axial width of both pulleys by an oil pressure that is regulated by the hydraulic control device VB based on a shift command from a control unit (ECU) 1 described below. An output shaft of the continuously variable speed change mechanism CVT (a rotating shaft of the secondary pulley) meshes with the counter gear CG, so that output rotation of the continuously variable speed change mechanism CVT is transmitted to the differential gear DG via the counter gear CG, and the output rotation is transmitted to the right and left driving wheels W via the differential gear DG so as to allow the differential rotation between the right and left driving wheels W.

Note that since the specific structure of the hybrid drive device HV described above is similar to that described in Japanese Patent Application Publication No. JP-A-2008-132812 (Japanese Patent Application Publication No. JP-A-2008-132812), detailed description thereof will be omitted.

The structure of the control device (the control unit) 1 of the hybrid vehicle will be described below with reference to FIG. 1. The control unit (ECU) 1 as the control device of the hybrid vehicle includes engine control unit 10 having a driving force maintaining control unit 11, a motor control unit 20 having a zero torque control unit 21, a shift control unit 30 having a vehicle speed maintaining control unit 31, and a motor protection control unit 40 having a temperature upper threshold map Tmap.

A motor temperature sensor (motor temperature detection unit) 51 provided in a stator coil of the motor MG, an input shaft rotational speed sensor 52 for detecting the rotational speed of the input shaft of the continuously variable speed change mechanism CVT, an output shaft rotational speed (vehicle speed) sensor 53 for detecting the rotational speed of the output shaft of the continuously variable speed change mechanism CVT or the rotational speed of the counter gear CG, and an accelerator operation amount sensor 54 for detecting the amount by which an accelerator pedal in a driver's seat, not shown, is depressed (namely the accelerator operation amount) are connected to the control unit 1 so that various signals are input to the control unit 1.

Note that the present embodiment is described with respect to an example in which the motor temperature sensor 51 is provided in the stator coil of the motor MG to directly detect the temperature of the motor MG. However, the present invention is not limited to this, and the motor temperature sensor 51 may indirectly detect the temperature of the motor MG by, e.g., detecting the temperature of coolant oil of the motor MG, or the like. That is, the motor temperature sensor 51 may be of any type as long as it can detect the temperature of the motor MG.

The engine control unit 10 freely controls the throttle opening of the engine EG, etc. to control driving/non-driving of the engine EG. When the engine EG is being driven during normal traveling, the engine control unit 10 controls an engine speed (the rotational speed of the engine) Ne and engine torque (the output torque of the engine) Te so as to bring the engine EG into an optimal fuel consumption state, based on the accelerator operation amount that is detected by the accelerator operation amount sensor 54, the vehicle speed (the rotational speed of the driving wheels) V that is detected by the output shaft rotational speed sensor 53, the speed ratio of the continuously variable speed change mechanism CVT, etc.

The motor control unit 20 freely controls electric power (a current, a voltage) from the battery B to control power running and regeneration of the motor MG. Especially when the engine EG is not being driven, the motor control unit 20 controls the output torque of the motor MG based on the accelerator operation amount that is detected by the accelerator operation amount sensor 54 (namely, output that is required by the driver). When the engine EG is being driven, and especially the rotational speed of the motor MG is less than a predetermined value (e.g., 13,000 rpm), the motor control unit 20 controls the motor MG so that the sum of the engine torque Te and motor torque Tmg becomes equal to the total torque according to the accelerator operation amount.

When the rotational speed of the motor MG becomes equal to or higher than the predetermined value (e.g., 13,000 rpm) at which it is difficult for the motor MG to output the motor torque Tmg, based on the detection result of the input shaft rotational speed sensor 52, the zero torque control unit 21 applies a current to control the output torque of the motor MG to zero (0). Thus, at high vehicle speeds at which the motor MG rotates at the predetermined rotational speed or more, the motor MG does not become a load, and the vehicle travels only by using the output of the engine EG.

The shift control unit 30 refers to, e.g., a shift map, not shown, based on the accelerator operation amount that is detected by the accelerator operation amount sensor 54, the vehicle speed V that is detected by the output shaft rotational speed sensor 53, etc., and determines the speed ratio of the continuously variable speed change mechanism CVT so that especially the engine EG has a rotational speed in the optimal fuel consumption state. The shift control unit 30 sends a command to the hydraulic control device VB so that the continuously variable speed change mechanism CVT has the determined speed ratio, The shift control unit 30 controls the speed ratio of the continuously variable speed change mechanism CVT in this manner.

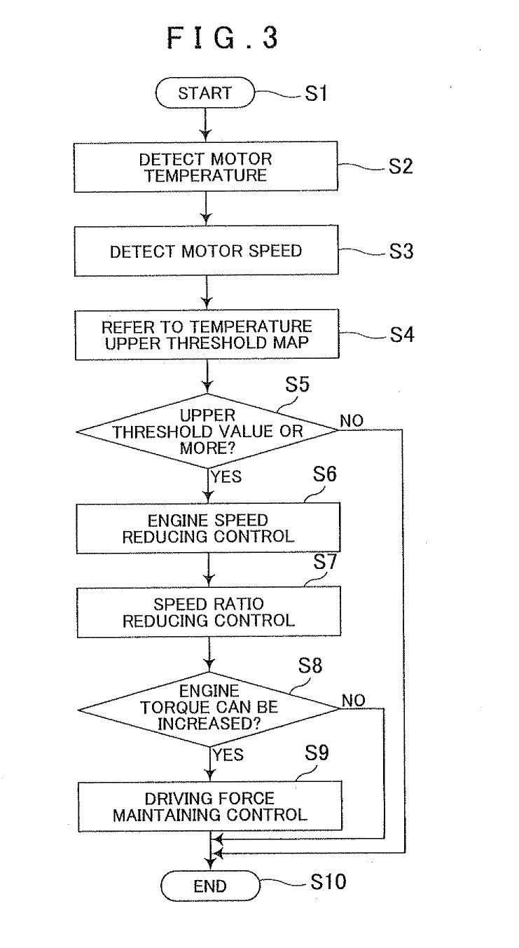

Motor protection control of the present invention will be described below based on the flowchart of FIG. 3 and with reference to FIGS. 1, 2, and 4. For example, in an ignition-on state, the motor protection control shown in FIG. 3 is started (S1). The motor protection control unit 40 first detects a temperature T of the motor MG by the motor temperature sensor 51 (S2), and then detects a motor speed (the rotational speed of the motor) Nmg by calculation based on the rotational speed of the input shaft of the continuously variable speed change mechanism CVT, which is detected by the input shaft rotational speed sensor 52, and the gear ratio of the deceleration mechanism PR (S3).

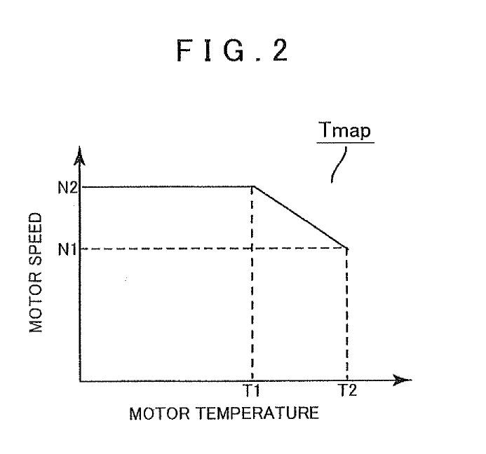

Then, the motor protection control unit 40 refers to the temperature upper threshold map Tmap shown in FIG. 2 (S3). As shown in FIG. 2, the upper threshold value shown by solid line in the drawing is recorded on the temperature upper threshold map Tmap, based on the relation between the motor speed Nmg and the motor temperature (the stator coil temperature) T. The upper threshold value is set so that the motor speed Nmg is equal to a rotation speed N2 (e.g., 20,000 rpm) when the motor temperature T is in the range from 0 to T1 (e.g., 150° C.) in which the vehicle is in a normal traveling state, and so that the motor speed Nmg becomes a rotation speed N1 (e.g., 13,000 rpm) at the motor temperature T2 when the motor MG is in a high temperature state with the motor temperature T ranging from T1 (e.g., 150° C.) to T2 (e.g., 160° C.), that is, the upper threshold value is set to be lower as the motor speed Nmg becomes higher.

Note that the upper threshold value of the rotational speed of the motor MG in the high temperature state corresponds to the case where the upper threshold value is equal to the predetermined rotational speed (e.g., 13,000 rpm) at which the zero torque control is started or more, namely, the rotational speed N1 or more. That is, in the case of the rotational speed N1 or less in which the zero torque control is not performed, excessive increase in the amount of heat generation of the motor MG from the amount of heat dissipation is not taken into consideration.

By referring to such a temperature upper threshold map Tmap (S3), the motor protection control unit 40 determines if the motor temperature T is equal to the upper threshold value or more (S5). If the motor temperature T is less than the upper threshold value (No in S5), the motor protection control unit 40 terminates the motor protection control (S10). On the other hand, if the motor temperature T is equal to or higher than the upper threshold value (Yes in S5), the motor MG may exceed its heat-resistant temperature. Thus, the motor protection control unit 40 performs engine speed reducing control (S6).

That is, the motor protection control unit 40 refers to the temperature upper threshold map Tmap based on the motor temperature T detected in the step S2, and reduces the engine speed Ne by, e.g., the engine control unit 10 changing the throttle opening and the fuel injection amount until the engine speed becomes equal to an engine speed that corresponds to the motor speed corresponding to the upper threshold value (namely, in view of the amount of deceleration by the deceleration mechanism PR).

Note that the engine speed can be reduced not only by changing the throttle opening and the fuel injection amount, but also by, e.g., retarding timings of the engine, or the like. That is, the engine speed can be reduced by any method as long as the engine speed can be reduced to an engine speed corresponding to the upper threshold value.

The engine EG operates together with the driving wheels W via the damper device D, the clutch C, the continuously variable speed change mechanism CVT, the counter gear CG, and the differential gear DG. Thus, when the engine speed Ne is reduced in this manner, the vehicle speed V reduces accordingly if no operation is performed. Thus, the vehicle speed maintaining control unit 31 performs speed ratio reducing control of reducing the speed ratio of the continuously variable speed change mechanism CVT toward a higher speed (that is, upshifting) according to the control of reducing the engine speed Ne by the motor protection control unit 40 (S7). That is, the vehicle speed maintaining control unit 31 performs control of basically maintaining the vehicle speed V, by calculating the amount by which the speed ratio is changed to upshift the continuously variable speed change mechanism CVT according to the amount by which the engine speed Ne is reduced, and upshifting the continuously variable speed change mechanism CVT in synchronization with the reduction in the engine speed Ne.

Note that the condition in which the motor temperature T is high and the engine speed reducing control is performed is the state in which the vehicle travels at a speed close to the highest vehicle speed of the vehicle performance. Due to the design of the continuously variable speed change mechanism CVT, the vehicle speed does not reach the highest value because of shortage of the driving force, when the speed ratio has the lowest value. Thus, in the above condition, the shift speed should be the shift speed from which the continuously variable speed change mechanism CVT can still be upshifted. Thus, the upshifting in synchronization with the reduction in the engine speed Ne cannot be disabled in the above condition.

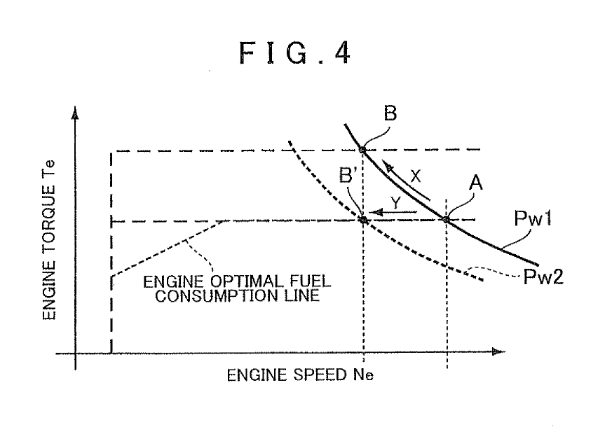

In the case of reducing the engine speed Ne as described above, since the total driving force (namely the total output (so-called horsepower) from the engine EG, which is transmitted to the driving wheels W, is the product of the engine speed Ne and the engine torque Te, as shown in FIG. 4, the engine speed Ne is shifted as shown by arrow Y, and the total driving force reduces from PW1 to PW2 as shown by point B′, if only the engine speed Ne is reduced from a traveling state shown by point A in which the vehicle is traveling by using the total driving force PW1. Thus, the total driving force for the traveling resistance decreases, and the vehicle speed V of the hybrid vehicle reduces as a result. That is, the highest vehicle speed of the vehicle performance is reduced.

As shown in FIG. 4, in the engine EG that is mounted on the hybrid vehicle, the throttle opening is adjusted along an engine optimal fuel consumption line so that the engine EG is basically in the optimal fuel consumption state. If the engine speed Ne is shifted along the engine optimal fuel consumption line, the total driving force decreases from PW1 to PW2 as shown by arrow Y. However, depending on the design of the engine EG (depending on the type of the engine that is mounted), there may be a margin for increasing only the engine torque Te by, e.g., changing the fuel injection amount without changing the engine speed Ne, even though the engine torque Te deviates from the engine optimal fuel consumption line.

As described above, regarding the engine EG of which design allows the engine torque Te to be increased with deviating from the engine optimal fuel consumption line, the engine torque Te is shifted as shown by arrow X by increasing the engine torque Te while reducing the engine speed Ne. That is, the engine torque Te can be shifted to point B so that the total driving force PW1 for the driving wheels W does not change.

Thus, as shown in FIG. 3, when performing the engine speed reducing control (S6) and the speed ratio reducing control (S7), the driving force maintaining control unit 11 determines if the engine torque Te can be increased or not (S8). If the engine torque Te can be increased according to the design of the engine EG (Yes in S8), the driving force maintaining control unit 11 performs driving force maintaining control in which the total driving force is maintained by increasing the engine torque Te by, e.g., increasing the fuel injection amount (S9). That is, the engine torque Te is shifted as shown by arrow X in FIG. 4 to maintain the total driving force for the traveling resistance, and thus to maintain the vehicle speed V. Then, the motor protection control is completed (S10).

On the other hand, if the engine torque Te cannot be increased according to the design of the engine EG (No in S8), the engine speed Ne is reduced along the optimal fuel consumption line. That is, the engine speed Ne is shifted as shown by arrow Y in FIG. 4, and the motor protection control is completed (S10). In this case, since the total driving force for the traveling resistance decreases from PW1 to PW2, the vehicle speed V decreases gradually.

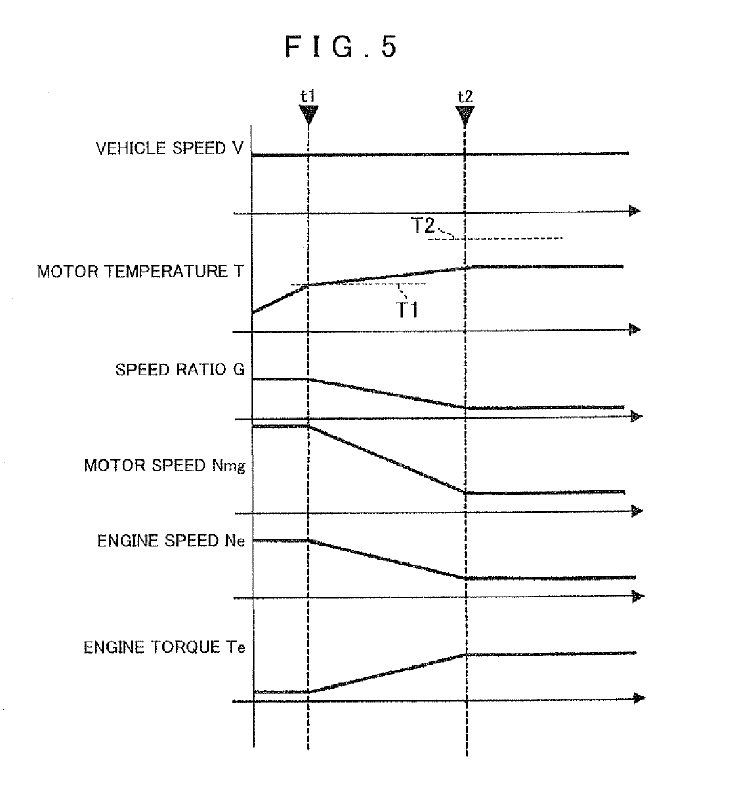

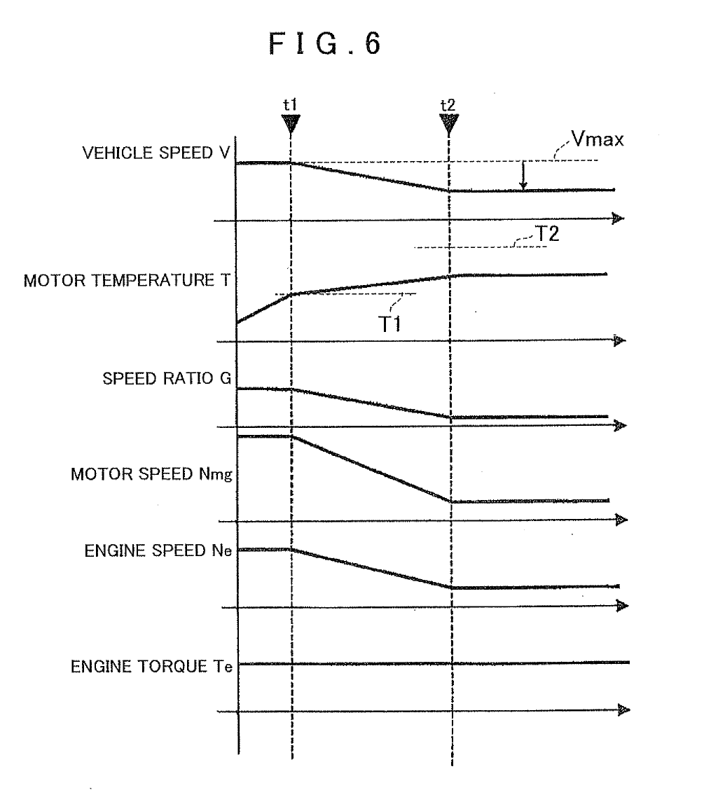

An example in which the vehicle travels when the motor protection control is performed will be described below with reference to FIGS. 5 and 6. FIG. 5 is a timing chart illustrating the motor protection control in the case where there is a margin for increasing the output torque of the engine EG (that is, in the case where the driving force maintaining control is performed). FIG. 6 is a timing chart illustrating the motor protection control in the case where there is not a margin for increasing the output torque of the engine EG.

First, the motor protection control in the case where there is a margin for increasing the output torque of the engine will be described. As shown in FIG. 5, when the vehicle travels at, e.g., a vehicle speed V close to the highest vehicle speed of the vehicle performance, the motor speed Nmg is also close to the highest design motor speed, and for example, the motor speed Nmg reaches the engine speed N2 (e.g., 20,000 rpm) shown in FIG. 2. In this case, the motor MG is controlled to zero torque by the zero torque control unit 21, and the motor temperature (the stator coil temperature) T increases gradually.

For example, if the motor temperature T reaches the temperature T1 shown in FIG. 2 at time t1, the motor temperature T is equal to or higher than the upper threshold value of the temperature upper threshold map Tmap (Yes in S5). Thus, the motor protection control unit 40 starts the engine speed reducing control (S6), and sends a command to change the throttle opening and the fuel injection amount to the engine EG to reduce the engine speed Ne along the upper threshold value. Thus, the rotational speed Nmg of the motor MG that operates together with the engine EG decreases via the deceleration mechanism PR, whereby an increase in temperature of the motor MG that is controlled to zero torque is reduced.

At the same time, the vehicle speed maintaining control unit 31 starts the speed ratio reducing control (S7), and sends a command to the hydraulic control device VB to reduce (upshift) the speed ratio G of the continuously variable speed change mechanism CVT. Moreover, the driving force maintaining control unit 11 determines if the engine torque can be increased when the rotational speed Ne of the engine EG is reduced. In this case, since there is a margin for increasing the output torque of the engine EG (Yes in FIG. 8), the driving force maintaining control unit 11 performs the driving force maintaining control (S9). That is, the driving force maintaining control unit 11 increases the engine torque Te as the engine speed Ne decreases, as shown by arrow X in FIG. 4.

Thus, from time t1, the engine speed Ne is reduced, and the motor speed Nmg is reduced accordingly, whereby the amount of heat generation by the motor temperature T decreases, and an increase in temperature decreases. Moreover, the speed ratio G of the continuously variable speed change mechanism CVT is reduced, thereby absorbing a change in the rotational speed of the output shaft of the continuously variable speed change mechanism CVT, which is caused by the reduction in the engine speed Ne. Furthermore, the engine torque Te is increased to maintain a constant total driving force PW1, whereby a constant vehicle speed V is maintained eventually.

If the amount of heat generation of the motor MG is balanced with the amount of heat dissipation thereof and the motor temperature T stops increasing at time t2, the motor temperature T settles at a value less than the upper threshold value in the temperature upper threshold map Tmap (No in S5). Accordingly, the motor temperature T does not exceed the temperature T2 at which continuous operation of the motor MG is disabled, and the motor MG is protected. Thus, all of the engine speed reducing control (S6), the speed ratio reducing control (S7), and the driving force maintaining control (S9) are completed. That is, the motor protection control is completed (S10), and the vehicle continues to travel at a speed close to the highest vehicle speed of the vehicle performance.

The motor protection control in the case where there is not a margin for increasing the output torque of the engine will be described below. Similarly, as shown in FIG. 6, when the vehicle travels at, e.g., a vehicle speed V close to the highest vehicle speed Vmax of the vehicle performance, the motor speed Nmg is also close to the highest design motor speed. Thus, the motor MG is controlled to zero torque by the zero torque control unit 21, and the motor temperature (the stator coil temperature) T increases gradually.

Similarly, for example, if the motor temperature T reaches the temperature T1 shown in FIG. 2 at time t1, the motor temperature T is equal to or higher than the upper threshold value (Yes in S5). Thus, the motor protection control unit 40 starts the engine speed reducing control (S6) to reduce the engine speed Ne along the upper threshold value. Thus, the rotational speed Nmg of the motor MG that operates together with the engine EG decreases, whereby an increase in temperature of the motor MG that is controlled to zero torque is reduced.

At the same time, the vehicle speed maintaining control unit 31 starts the speed ratio reducing control (S7) to reduce (upshift) the speed ratio G of the continuously variable speed change mechanism CVT. The driving force maintaining control unit 11 determines if the engine torque can be increased when the rotational speed Ne of the engine EG is reduced. In this case, since there is not a margin for increasing the output torque of the engine EG (No in FIG. 8), the engine speed Ne is reduced along the optimal fuel consumption line, as shown by arrow Y in FIG. 4, and the engine torque Te is not increased.

Thus, from time t1, the engine speed Ne is reduced, and the motor speed Nmg is reduced accordingly, whereby the amount of heat generation by the motor temperature T decreases, and an increase in temperature decreases. Moreover, the speed ratio G of the continuously variable speed change mechanism CVT is reduced, thereby absorbing a change in the rotational speed of the output shaft of the continuously variable speed change mechanism CVT, which is caused by the reduction in the engine speed Ne. However, since the total driving force decreases from PW1 to PW2 (see FIG. 4), the traveling resistance overcomes the vehicle speed V, and the vehicle speed V is eventually decreased.

If the amount of heat generation of the motor MG is balanced with the amount of heat dissipation thereof and the motor temperature T stops increasing at time t2, the motor temperature T settles at a value less than the upper threshold value of the temperature upper threshold map Tmap (No in S5). Accordingly, the motor temperature T does not exceed the temperature T2 at which continuous operation of the motor MG is disabled, and the motor MG is protected. Thus, the engine speed reducing control (S6) and the speed ratio reducing control (S7) are completed. That is, the motor protection control is completed (S10), and the vehicle continues to travel at a speed V slightly lower than the highest vehicle speed of the vehicle performance.

As described above, according to the control device 1 of the hybrid vehicle, the motor protection control unit 40 reduces the engine speed Ne when the temperature T of the motor MG reaches the upper threshold value or more while the motor MG is being rotated at a predetermined rotational speed (e.g., 13,000 rpm) or more by driving rotation of the engine EG and is being controlled to zero torque. Thus, the motor speed Nmg can be reduced, and the amount of heat generation by the zero torque control can be reduced, whereby the motor temperature T can be reduced, and the motor MG can be protected. This can eliminate the need to improve the performance of the cooling structure of the motor MG, and to increase the size of the motor MG, whereby cost reduction and a compact structure of the hybrid vehicle can be implemented.

As shown in FIG. 2, especially at the temperature T1 or more in a high temperature state, the upper threshold value is set so as to decrease as the motor speed Nmg increases. This can prevent the motor temperature T from increasing excessively according to the motor speed Nmg, whereby the motor MG can be reliably protected.

When the engine speed Ne is reduced by the motor protection control unit 40, the vehicle speed maintaining control unit 31 shifts the speed ratio G of the continuously variable speed change mechanism CVT toward a higher speed according to the reduction in the engine speed Ne. This can prevent the vehicle speed V from reducing with the reduction in the engine speed Ne.

When the engine speed Ne is reduced by the motor protection control unit 40, and especially the output torque of the engine EG can be increased, the driving force maintaining control unit 11 increases the engine torque Te so as to maintain the total driving force PW1 that is transmitted to the driving wheels W. This can prevent the vehicle speed V from reducing due to a reduction in total driving force that is transmitted to the driving wheels W.

The motor MG is coupled to the input shaft of the continuously variable speed change mechanism CVT via the deceleration mechanism PR. Thus, although the output torque of the motor MG can be amplified and transmitted to the driving wheels W, the motor MG rotates at a higher speed as compared to the engine speed Ne. However, since the motor protection control unit 40 reduces the engine speed Ne when the motor temperature T reaches the upper threshold value or more, the motor speed Nmg can be significantly reduced, whereby the motor MG can be reliably protected.

The above embodiment is described with respect to an example in which a belt type continuously variable speed change mechanism is used as the continuously variable speed change mechanism CVT. However, the present invention is not limited to this, and a stepped automatic speed change mechanism may be used. That is, any type of speed change mechanism may be used in the present invention. In particular, since only the highest vehicle speed performance as a vehicle is reduced even with a speed change mechanism that is unable to upshift according to the control of reducing the engine speed Ne, the present invention may also be applied to such speed change mechanism that does not upshift according to the control of reducing the engine speed Ne.

In the present embodiment, the structure in which the engine and the motor are arranged in parallel in a stage that precedes the speed change mechanism (on the upstream side of a driving force transmission path) is described as an example of the hybrid vehicle to which the present invention can be applied. However, the present invention is not limited to this, and the engine and the motor may be coupled together in any relation as long as the motor is rotated together with the engine while the vehicle is traveling by using the driving force of the engine.

The control device of the hybrid vehicle according to the present invention can be used as a control device of a hybrid vehicle such as a passenger car and a truck, and is especially preferably used in a control device of an automatic transmission for which protection of a motor is required while implementing cost reduction and a compact structure by simplifying a cooling system and reducing the size of the motor.

What is claimed is:

1. A control device of a hybrid vehicle, comprising:
an engine;
a motor that rotates together with the engine at least during traveling by using a driving force of the engine;
a speed change mechanism that shifts rotation of the engine and the motor to transmit the shifted rotation to a driving wheel;
a zero torque control unit that controls output torque of the motor to zero torque when a rotational speed of the motor reaches a predetermined rotation speed or more by driving rotation of the engine;
a motor temperature detection unit that detects a temperature of the motor; and
a motor protection control units that reduces a rotational speed of the engine when the temperature of the motor reaches an upper threshold value or more while the motor is being rotated at the predetermined rotational speed or more by the driving rotation of the engine.

2. The control device of the hybrid vehicle according to claim 1, wherein
the upper threshold value is set to be lower as the rotational speed of the motor becomes higher.

3. The control device of the hybrid vehicle according to claim 1, further comprising:
a vehicle speed maintaining control unit that shifts a shift speed of the speed change mechanism toward a higher speed according to reduction in the rotational speed of the engine, when the rotational speed of the engine is reduced by the motor protection control unit.

4. The control device of the hybrid vehicle according to claim 1, further comprising:
a driving force maintaining control unit that increases output torque of the engine so as to maintain the driving force that is transmitted to the driving wheel, when the rotational speed of the engine is reduced by the motor protection control unit.

5. The control device of the hybrid vehicle according to claim 1, wherein
the motor is coupled to an input shaft of the speed change mechanism via a deceleration mechanism.

6. The control device of the hybrid vehicle according to claim 3, further comprising:
a vehicle speed maintaining control unit that shifts a shift speed of the speed change mechanism toward a higher speed according to reduction in the rotational speed of the engine, when the rotational speed of the engine is reduced by the motor protection control unit.

7. The control device of the hybrid vehicle according to claim 6, further comprising:
a driving force maintaining control unit that increases output torque of the engine so as to maintain the driving force that is transmitted to the driving wheel, when the rotational speed of the engine is reduced by the motor protection control unit.

8. The control device of the hybrid vehicle according to claim 7, wherein
the motor is coupled to an input shaft of the speed change mechanism via a deceleration mechanism.

9. The control device of the hybrid vehicle according to claim 2, further comprising:
a driving force maintaining control unit that increases output torque of the engine so as to maintain the driving force that is transmitted to the driving wheel, when the rotational speed of the engine is reduced by the motor protection control unit.

10. The control device of the hybrid vehicle according to claim 2, wherein
the motor is coupled to an input shaft of the speed change mechanism via a deceleration mechanism.

11. The control device of the hybrid vehicle according to claim 3, further comprising:
a driving force maintaining control unit that increases output torque of the engine so as to maintain the driving force that is transmitted to the driving wheel, when the rotational speed of the engine is reduced by the motor protection control unit.

12. The control device of the hybrid vehicle according to claim 3, wherein
the motor is coupled to an input shaft of the speed change mechanism via a deceleration mechanism.

13. The control device of the hybrid vehicle according to claim 4, wherein
the motor is coupled to an input shaft of the speed change mechanism via a deceleration mechanism.

14. The control device of the hybrid vehicle according to claim 6, wherein
the motor is coupled to an input shaft of the speed change mechanism via a deceleration mechanism.

15. The control device of the hybrid vehicle according to claim 9, wherein
the motor is coupled to an input shaft of the speed change mechanism via a deceleration mechanism.

16. The control device of the hybrid vehicle according to claim 11, wherein
the motor is coupled to an input shaft of the speed change mechanism via a deceleration mechanism.
